(19) United States
(12) Patent Application Publication
(10) Pub. No.: US 2008/0182583 A1
(43) Pub. Date: Jul. 31, 2008

(54) METHODS AND APPARATUS FOR DETERMINING OPTIMAL RF TRANSMITTER PLACEMENT VIA A COVERAGE METRIC

(75) Inventors: Vinh Le, Fremont, CA (US); Chris Hinsz, San Jose, CA (US)

Correspondence Address: INGRASSIA FISHER & LORENZ, P.C., 7010 E. COCHISE ROAD, SCOTTSDALE, AZ, 85253, US

(73) Assignee: SYMBOL TECHNOLOGIES, INC., Holtsville, NY (US)

(21) Appl. No.: 11/669,374

(22) Filed: Jan. 31, 2007

(51) Int. Cl. H04Q 7/36

(52) U.S. Cl. 455/446

(57) ABSTRACT

Systems and methods are provided for optimizing the placement of RF components within an environment. The system operates by defining a spatial model associated with the environment, determining a first placement location of the RF device within the spatial model, determining a coverage area associated with the RF device, identifying a set of gaps associated with the coverage area, calculating a coverage metric based on the set of gaps, determining a second placement location of the RF device within the spatial model based on the coverage metric, and placing the AP in the second placement location within the environment if the coverage metric is less than or equal to a predetermined threshold.

### TECHNICAL FIELD

The present invention relates to wireless local area networks (WLANs) and other networks incorporating RF elements and/or RF devices. More particularly, the present invention relates to methods for automating the placement of RF devices, such as access points, within an environment.

### BACKGROUND

There has been a dramatic increase in demand for mobile connectivity solutions utilizing various wireless components and WLANs. This generally involves the use of wireless access points that communicate with mobile devices using one or more RF channels (e.g., in accordance with one or more of the IEEE 802.11 standards).

At the same time, RFID systems have achieved wide popularity in a number of applications, as they provide a cost-effective way to track the location of a large number of assets in real time. In large-scale applications such as warehouses, retail spaces, and the like, many RFID tags may exist in the environment. Likewise, multiple RFID readers are typically distributed throughout the space in the form of entryway readers, conveyer-belt readers, mobile readers, and the like, and these multiple components may be linked by network controller switches and other network elements.

Because many different RF transmitters and other components may exist in a particular environment, the deployment and management of such systems can be difficult and time-consuming. For example, it is desirable to configure access points and other such RF components such that RF coverage is complete within certain areas of the environment. Accordingly, there exist various RF planning systems that enable a user to predict indoor/outdoor RF coverage. The result is a prediction as to where the transmitters should be placed within the environment. Such systems are unsatisfactory in a number of respects, however, as they fall short of the requirements due to the presence of gaps and holes.

### BRIEF SUMMARY

In general, systems and methods are provided for optimizing the placement of RF components (e.g., access points, access ports, RF antennas) within an environment. A method in accordance with one embodiment includes: defining a spatial model associated with the environment; determining a first placement location of the RF device within the spatial model; determining a coverage area associated with the RF device; identifying a set of gaps associated with the coverage area; calculating a coverage metric based on the set of gaps; determining a second placement location of the RF device within the spatial model based on the coverage metric; and placing the RF device in the second placement location within the environment if the coverage metric is less than or equal to a predetermined threshold.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is an example floor plan useful in depicting systems and methods in accordance with the present invention;

FIG. 2 is a conceptual top view of exemplary coverage areas for two RF transmitters in an environment;

FIG. 3 is the system of FIG. 2 after relocation of one of the RF transmitters; and

FIG. 4 is the system of FIG. 3 after further relocation of one of the RF transmitters.

### DETAILED DESCRIPTION

The present invention relates to a method for optimizing the placement of RF components within an environment to maximize RF coverage. In this regard, the following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of data transmission and data formatting protocols and that the system described herein is merely one example embodiment of the invention.

For the sake of brevity, conventional techniques related to signal processing, data transmission, signaling, network control, the 802.11 family of specifications, wireless networks, RFID systems and specifications, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example,” rather than “model.” Although the figures may depict example arrangements of elements, additional intervening elements, devices, features, or components may be present in an embodiment of the invention.

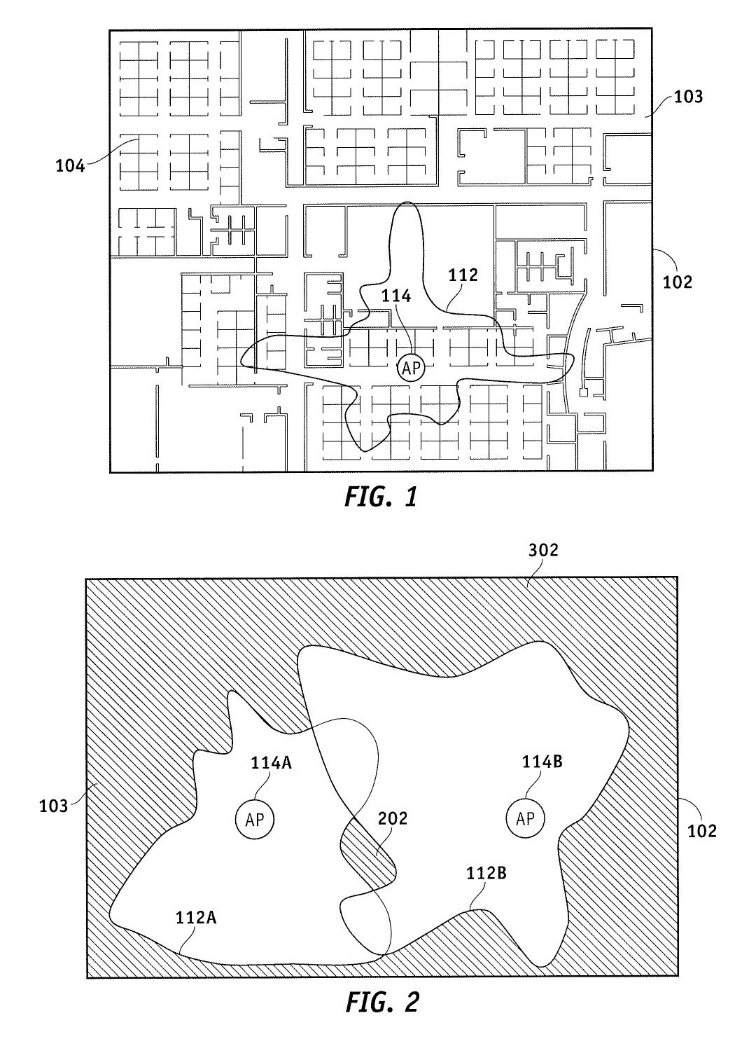

Referring to the conceptual plan view shown in FIG. 1, an access port or access point (“AP”) 114 or other RF device is provided within an environment 103 defined by a boundary 102 (which may be indoors and/or outdoors). AP 114 has an associated RF coverage area (or simply “coverage”) 112, which corresponds to the effective range of its antenna or RF transmitter, as described in further detail below. Various mobile units (“MUs”) (not shown) may communicate with AP 114, which itself will typically be part of a larger network.

Environment 103, which may correspond to a workplace, a retail store, a home, a warehouse, or any other such space, will typically include various physical features 104 that affect the nature and/or strength of RF signals received and/or sent by AP 114. Such feature include, for example, architectural structures such as doors, windows, partitions, walls, ceilings, floors, machinery, lighting fixtures, and the like.

Boundary 102 may have any arbitrary geometric shape, and need not be rectangular as shown in the illustration. Indeed, boundary 102 may comprise multiple topologically unconnected spaces, and need not encompass the entire workplace in which AP 114 is deployed. Furthermore, the present invention is not limited to two-dimensional layouts; it may be extended to three dimensional spaces as well.

AP 114 is configured to wirelessly connect to one or more mobile units (MUs) (not shown) and communicate one or more switches, routers, or other networked components via appropriate communication lines (not shown). Any number of additional and/or intervening switches, routers, servers, and other network components may also be present in the system.

At any given time, 114 may have a number of associated MUs, and is typically capable of communicating with through multiple RF channels. This distribution of channels varies greatly by device, as well as country of operation. For example, in accordance with an 802.11(b) deployment there are fourteen overlapping, staggered channels, each centered 5 MHz apart in the RF band.

As described in further detail below, AP 114 includes hardware, software, and/or firmware capable of carrying out the functions described herein. Thus, AP may comprise one or more processors accompanied by storage units, displays, input/output devices, an operating system, database management software, networking software, and the like. Such systems are well known in the art, and need not be described in detail here.

For wireless data transport, AP 114 may support one or more wireless data communication protocols—e.g., RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; GPRS; and proprietary wireless data communication protocols such as variants of Wireless USB.

Referring now to FIG. 2, when multiple APs are positioned within boundary 102, various gaps or “holes” in coverage (or “coverage areas”) may exist. For simplicity, the gaps are shown be two-dimensional; in actual applications they will have a three-dimensional nature. In a typical application, AP 114A may have been previously placed, and a new AP 114B is inserted to help with RF coverage. As illustrated, AP 114A has a corresponding coverage 112A, and AP 114B has a corresponding coverage 12B. These coverage areas may have any arbitrary shape or size, depending upon factors known in the art. For example, these coverage areas may be determined through a receiver signal strength indicator (RSSI) calculation, as is known in the art.

As shown, a gap 202 exists between coverage areas 112A and 112B, and a gap 204 exists between boundary 102 and the outer reaches of areas 112A and 112B. In accordance with the present invention, APs 114A and/or 114B are relocated to optimal positions based on a coverage metric, which may be iteratively recalculated adaptively until it reaches a predetermined coverage metric threshold (or simply “threshold”).

The coverage metric may be any quantitative or qualitative measure of the gaps within an area at any given time. In one embodiment, for example, the coverage metric is equal to the total planar area of all gaps within the relevant area. The coverage metric may also take into account and assist with reducing overlapping coverage areas. In an alternate embodiment, the coverage metric may relate to how much RF coverage overlap can be allowed.

The coverage metric calculations are computed based on gaps in RF coverage present in the environment—which change size and/or position as the various APs 114 are moved to reduce the coverage metric within that area. In the illustrated embodiment, for example, two gaps are present: gap 202 and gap 302. Each of these gaps has planar geometrical attributes such as area, shape, centroid, and the like, all of which may be calculated (e.g., using suitable hardware and software) given the shapes of coverage areas 112.

Operation of the system generally proceeds as follows. First, modeling information regarding the environment and components within the environment 103 are collected to produce a spatial model. This information may include, for example, building size and layout, country code, transmit power per AP, antenna gain, placement constraints, transmit power constraints, data rate requirements, coverage requirements, barrier information, and the like.

The size and shape of the coverage areas 112 within boundary 102 are then determined for the set of APs 114. Next, any contiguous gaps (e.g., gaps 202 and 302) within environment 103 are identified, and the shape, size, and any other suitable attributes for those gaps is computed. The coverage metric is then computed, based, for example, on the total area of gaps 202 and 302.

Once the coverage metric is computed, the system determines a new position for one or more of the APs—e.g., the most recent AP to enter the environment. Next, the AP (e.g., AP 114B) is moved within the spatial model to that new position. The new position may be determined by defining an angular direction in which the AP should move, as well as a step size (i.e., distance) that defines the scalar distance. The step size may be selected in accordance with known principles to achieve the desired stability and convergence time.

The direction of AP movement during an iteration may be specified in any suitable manner based on gap locations. In one embodiment, an average gap metric is computed based on an integration or discrete summation of the distances from the AP to points within a gap. The angular direction may correspond a line leading from the current placement of the AP to an extrema (i.e., a point on the perimeter) of one of the gaps. In a particular embodiment, the angular direction is defined by the point on the perimeter of the gap that is farthest away from the current position of the AP. In this regard, the environment may be discretized into a grid for computational purposes.

After the subject AP has been relocated, the system again determines the size and shape of the coverage areas and recomputes the coverage metric. If the coverage metric is equal to or less than a predefined threshold, the system once again computes a new position for one or more of the APs, and the process continues as before until the predefined threshold is reached or it is determined that the process should otherwise stop (e.g., due to the non-existence of a solution, non-convergence, or a time out event). The predefined threshold may be selected to achieve any particular design objective—e.g., the coverage metric value corresponding to the minimum signal level in which a certain data rate can operate.

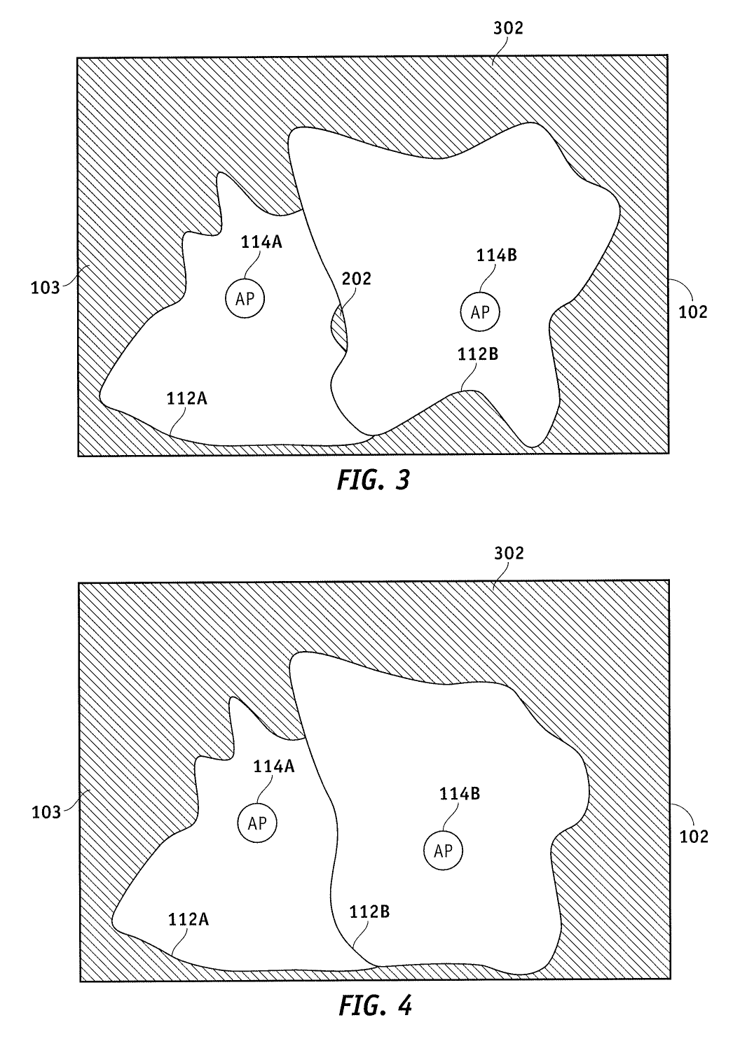

FIGS. 3 and 4 shows the example of FIG. 2 after successively relocating AP 114B closer to AP 114A. As depicted, the gaps 202 and 302 of are gradually eliminated or substantially eliminated such that the coverage metric is within the predefined threshold. The shape and size of coverage areas 112A and 112B have changed accordingly. The system may then proceed to improve coverage either by moving AP 114A or 114B, or adding a new AP within boundary 102.

The methods described above may be performed in hardware, software, or a combination thereof. For example, in one embodiment one or more software modules are configured to be executed on a general purpose computer having a processor, memory, I/O, display, and the like.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A method of positioning an RF device within an environment, comprising the steps of:
defining a spatial model associated with the environment;
determining a first placement location of the RF device within the spatial model;
determining a coverage area associated with the RF device;
identifying a set of gaps associated with the coverage area;
calculating a coverage metric based on the set of gaps;
determining a second placement location of the RF device within the spatial model based on the coverage metric;
calculating a second coverage metric based on a second set of gaps; and
placing the RF device in the second placement location within the environment if the second coverage metric is less than or equal to a predetermined threshold value.

2. The method of claim 1, further including repeating the step of identifying the set of gaps when the coverage metric is greater than the predetermined threshold.

3. The method of claim 1, wherein the coverage metric is based on the area of the set of gaps.

4. The method of claim 3, wherein the coverage metric includes a measure of overlap associated with coverage area.

5. The method of claim 1, wherein determining the coverage area associated with the RF device includes performing an RSSI calculation.

6. The method of claim 1, wherein defining the spatial model includes determining the location of one or more barriers within the environment.

7. A system for positioning an RF device within an environment, comprising:
a processor configured to accept a spatial model associated with the environment, determine a first placement location of the RF device within the spatial model, determine a coverage area associated with the RF device, identify a set of gaps associated with the coverage area, calculate a first coverage metric based on the set of gaps, determine a second placement location of the RF device within the spatial model based on the second coverage metric, and compare the second coverage metric to a predetermined threshold; and
a display for displaying the spatial model and the second placement location.

8. The system of claim 7, wherein the processor computes the coverage metric based on the area of the set of gaps.

9. The system of claim 8, wherein the processor computes the coverage metric based in part on overlap associated with the coverage area.

10. The system of claim 7, wherein the processor computes the coverage area associated with the RF device by performing an RSSI calculation.

11. The system of claim 7, wherein the spatial model includes the location of one or more barriers within the environment.

12. The system of claim 7, wherein the RF device is a wireless access point.

13. The system of claim 12, wherein the wireless access point conforms to a 802.11 specification.

14. A method of positioning a plurality of RF transmitters within an environment, comprising the steps of:
defining a spatial model associated with the environment and the RF transmitters;
determining a first set of placement locations for the plurality of RF transmitters within the spatial model;
determining a set of coverage areas associated with the plurality of RF transmitters;
identifying a set of gaps associated with the set of coverage areas;
calculating a coverage metric based on the set of gaps;
determining a second placement location of at least one of the RF transmitters within the spatial model based on the coverage metric;
calculating a second coverage metric based on a second set of gaps; and
placing the at least one RF transmitter in the second placement location within the environment if the second coverage metric is less than or equal to a predetermined threshold value.

15. The method of claim 14, wherein positioning the plurality of RF transmitters includes positioning devices selected from the group consisting of RFID devices, WiMax devices, Bluetooth devices, and UWB devices.
